(19) United States
(12) Patent Application Publication
(10) Pub. No.: US 2020/0274941 A1
(43) Pub. Date: Aug. 27, 2020

(54) RECEPTION APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Toru Suneya, Yokohama-shi (JP)

(21) Appl. No.: 16/788,643

(22) Filed: Feb. 12, 2020

(30) Foreign Application Priority Data
Feb. 27, 2019 (JP) 2019-034738

(51) Int. Cl. H04L 29/08; H04L 29/06

(52) U.S. Cl. CPC H04L 67/26; H04L 67/10; H04L 65/1073; H04L 65/608; H04L 67/02

(57) ABSTRACT

A reception apparatus that receives push-distributed data from another apparatus determines, based on information of data to be push-distributed, whether to register a predetermined function used to allow a predetermined application to use the data, registers the predetermined function determined to be registered in the determining, and executes the predetermined function when the push-distributed data is received if, concerning the data, the predetermined function has been registered in the registering.

### BACKGROUND OF THE INVENTION

### Field of the Invention

The present invention relates to a use control technique for push-distributed data.

### Description of the Related Art

Recently, in a Web server or a Web browser, support of HTTP/2 has progressed and gradually become widespread. HTTP/2 adds various functions for improving performance to HTTP/1.1. Server push that is one of the functions transmits a script, image data, style sheet, and the like from the server side before a request from a client is received. This allows a Web browser to quickly display a Web page.

As a technique of streaming-distributing video data by HTTP, MPEG-DASH (Dynamic Adaptive Streaming over HTTP: ISO/IEC 23009-1) standardized by ISO has become popular. In recent years, a technique of improving throughput or reducing delays using the server push function of HTTP/2 or WebSocket is standardized as MPEG-DASH part 6 (ISO/IEC 23009-6).

A client of MPEG-DASH is generally a Web application that is created by JavaScript® or the like and operates on a Web browser. A pushed segment is saved in the cache of the Web browser. For this reason, the Web application needs to obtain the segment from the cache of the Web browser by the GET method of HTTP. That is, the pushed segment is not directly received by the Web application but saved in the cache of the Web browser first. Hence, during the time after the segment is saved in the cache until the Web application obtains the desired segment by the GET method, the segment stays in the cache of the Web browser.

Japanese Patent Laid-Open No. 2005-519409 describes that a Web browser obtains a push message from a Web server, and a user interface on the Web browser is changed in accordance with it. However, the technique described in Japanese Patent Laid-Open No. 2005-519409 only notifies a user that the message has been pushed, and a mechanism that allows a specific application to early use data saved in the cache of the Web browser has not been examined.

### SUMMARY OF THE INVENTION

The present invention provides a technique of shortening a time until, in a reception apparatus, a specific application can use data obtained by push from a partner apparatus.

According to one aspect of the present invention, there is provided a reception apparatus configured to receive push-distributed data from another apparatus, comprising: one or more processors; and one or more memories, which stores one or more computer-readable instructions that cause, when executed by the one or more processors, the reception apparatus to: determine, based on information of data to be push-distributed, whether to register a predetermined function used to allow a predetermined application to use the data; register the predetermined function determined to be registered in the determination; and execute the predetermined function when the push-distributed data is received if, concerning the data, the predetermined function has been registered by the registration.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a system;

FIG. 2 is a block diagram showing an example of the hardware arrangement of a reception apparatus;

FIG. 3 is a block diagram showing an example of the functional arrangement of the reception apparatus;

FIG. 4 is a sequence chart for explaining the time difference between generation and obtaining of a segment;

FIG. 5 is a sequence chart for explaining the time difference between generation and obtaining of a segment;

FIG. 6 is a sequence chart for schematically explaining the processing contents of the reception apparatus;

FIG. 7 is a flowchart showing an example of the procedure of callback permission determination executed by the reception apparatus;

FIG. 8 is a view showing an example of a request of a push instruction and a response by a Web server; and

FIGS. 9A and 9B are views showing another example of the request of the push instruction and the response by the Web server.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

(System Arrangement)

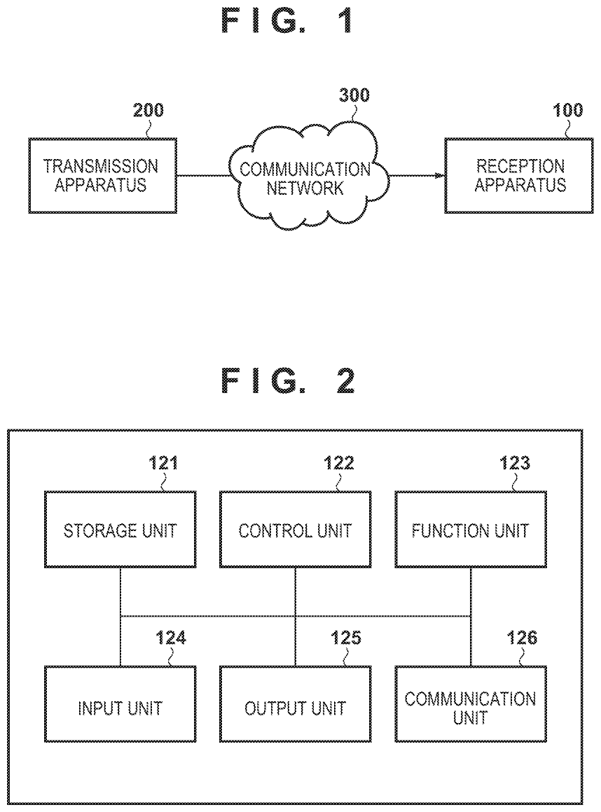

FIG. 1 shows an example of the arrangement of a content distribution system according to this embodiment. This system is a system configured to distribute a media content such as a video content or an audio content, and includes a transmission apparatus 200 that distributes a media content, and a reception apparatus 100 that receives the media content. In an example, the reception apparatus 100 is configured to be communicable with the transmission apparatus 200 via a communication network 300. Note that in the example of FIG. 1, one reception apparatus 100 and one transmission apparatus 200 are shown. However, for at least one of the apparatuses, a plurality of apparatuses may exist.

The reception apparatus 100 has a content reproduction/display function, a communication function, and a function of accepting an input from a user, and can be, for example, an arbitrary electronic device such as a smartphone, a PC (Personal Computer), a television, or a portable telephone. The transmission apparatus 200 may be, for example, an arbitrary electronic device such as a camera, a video camera, a smartphone, a PC, or a portable telephone. The communication network 300 can be, for example, an arbitrary communication network regardless of wired communication or wireless communication. The communication network can be any one of various kinds of networks such as the Internet/intranet and a LAN (Local Area Network)/WAN (Wide Area Network). In addition, the wired communication interface can be an interface complying with the Ethernet standard. However, another interface may be used. The wireless communication interface may be an interface complying with a wireless LAN standard complying with the IEEE802.11 standard series, or an interface complying with a standard such as WAN such as 3G/4G/LTE or Bluetooth® may be used. Note that as a wireless connection form, connection in an infrastructure network may be used, or connection in an ad-hoc network may be used. In addition, the communication network 300 may be constituted by combining a wired communication path and a wireless communication path. That is, the communication network 300 can have an arbitrary form as long as connection is established between the reception apparatus 100 and the transmission apparatus 200, and communication is performed.

(Arrangement of Reception Apparatus)

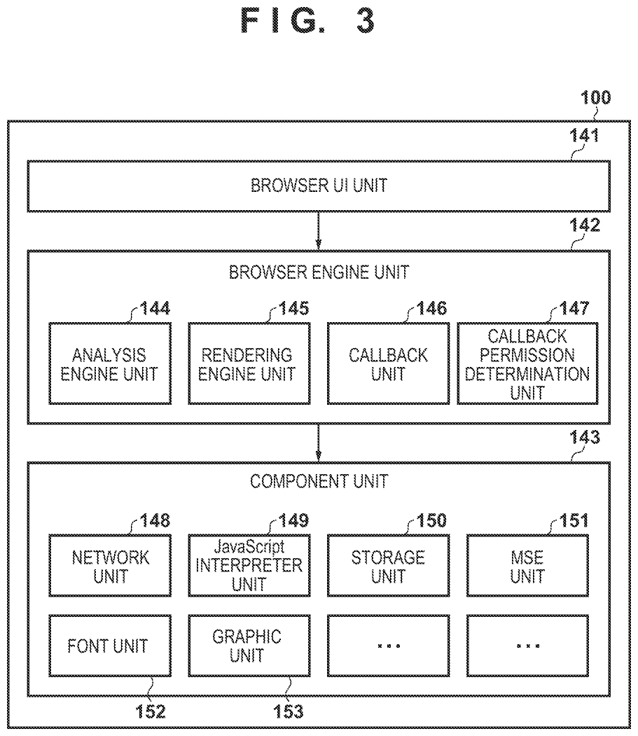

FIG. 2 shows the hardware arrangement of the reception apparatus 100 according to this embodiment. The reception apparatus 100 includes, as its hardware arrangement, for example, a storage unit 121, a control unit 122, a function unit 123, an input unit 124, an output unit 125, and a communication unit 126. Note that the arrangement shown in FIG. 2 is merely an example, and the reception apparatus 100 may include only part of the arrangement shown in FIG. 2, or may have an arrangement other than that shown in FIG. 2.

The storage unit 121 is formed by one or more memories, that is, both of a ROM and a RAM or one of them, and stores programs configured to perform various kinds of operations to be described later and various kinds of information such as communication parameters for wireless communication. Here, ROM is short for Read Only Memory, and RAM is short for Random Access Memory. Note that other than the memories such as a ROM and a RAM, a storage medium such as a flexible disk, a hard disk, an optical disk, a magnetooptical disk, a CD-ROM, a CD-R, a magnetic tape, a non-volatile memory card, or a DVD may be used as the storage unit 121.

The control unit 122 is formed by, for example, one or more processors such as a CPU and an MPU, an ASIC (Application Specific Integrated Circuit), a DSP (Digital Signal Processor), an FPGA (Field Programmable Gate Array), or the like. Here, CPU is an acronym of Central Processing Unit, and MPU is an acronym of Micro Processing Unit. The control unit 122 executes the programs stored in the storage unit 121, thereby controlling the entire reception apparatus 100. Note that the control unit 122 may control the entire reception apparatus 100 by cooperation of the programs stored in the storage unit 121 and an OS (Operating System).

In addition, the control unit 122 controls the function unit 123 to execute predetermined processing such as image capturing, printing, or projection. The function unit 123 is hardware used by the reception apparatus 100 to execute predetermined processing. For example, if the reception apparatus 100 is a camera, the function unit 123 is an image capturing unit and performs image capturing processing. Data to be processed by the function unit 123 may be data stored in the storage unit 121, or may be data communicated with an STA via the communication unit 126 to be described later.

The input unit 124 accepts various kinds of operations from the user. The output unit 125 performs various kinds of outputs for the user. Here, the output by the output unit 125 includes at least one of display on a screen, audio output by a speaker, vibration output, and the like. Note that both the input unit 124 and the output unit 125 may be implemented by one module, like a touch panel.

The communication unit 126 controls wired communication or wireless communication, or controls IP communication. The reception apparatus 100 communicates a media content such as video data or audio data with another communication apparatus (transmission apparatus 200) via the communication unit 126.

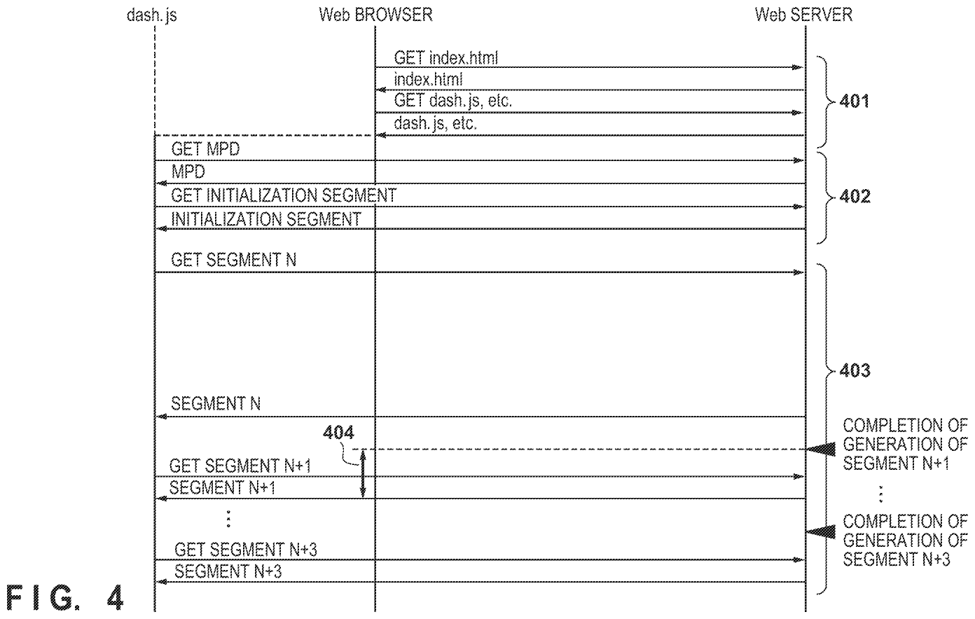

FIG. 3 is a block diagram showing an example of the functional arrangement of the reception apparatus 100. In an example, the reception apparatus 100 includes a browser UI unit 141, a browser engine unit 142, and a component unit 143. The browser UI unit 141 provides a user interface necessary for browsing, such as an address bar, a forward/back button, or a bookmark menu. The browser engine unit 142 includes, for example, an analysis engine unit 144, a rendering engine unit 145, a callback unit 146, and a callback permission determination unit 147. The analysis engine unit 144 analyzes HTML, a style sheet, or the like. The rendering engine unit 145 has a function of rendering the parts of HTML using the function of the component unit 143 based on the analysis result of the analysis engine unit 144 and laying out and displaying them. The callback unit 146 executes callback of a registered predetermined function when the reception apparatus 100 receives predetermined data. The callback permission determination unit 147 determines whether to permit registration of the function to be executed by the callback unit 146 or not. The component unit 143 includes functional modules such as a network unit 148, a JavaScript interpreter unit 149, a storage unit 150, an MSE unit 151, a font unit 152, and a graphic unit 153. The network unit 148 executes processing concerning network access, such as transmission of an HTTP (HyperText Transfer Protocol) request and content reception from a server. The JavaScript interpreter unit 149 analyzes and executes JavaScript. The storage unit 150 provides a cache function of semi-permanently saving data received from the server. The MSE unit 151 decodes received video data or audio data and reproduces/displays it. Note that MSE is an acronym of Media Source Extension that is an API for JavaScript created for streaming reproduction by HTTP. The font unit 152 and the graphic unit 153 respectively provide functions of rendering a text font and image data for display. Note that the functional units shown in FIG. 3 can be implemented in the reception apparatus as dedicated hardware such as an ASIC or software. If the units are implemented as hardware, a dedicated hardware module in which each or some of the functional units are integrated can be implemented. If the units are implemented as software, programs configured to execute each functional unit are stored in the storage unit 121 of the reception apparatus described above, and appropriately read out and executed by the processor of the control unit 122.

(Time Difference from Generation of Segment to Obtaining)

The time difference from generation of a segment in a Web server to obtaining of the segment by an application in the reception apparatus will be schematically explained next for a case in which server push is not used and a case in which server push is used.

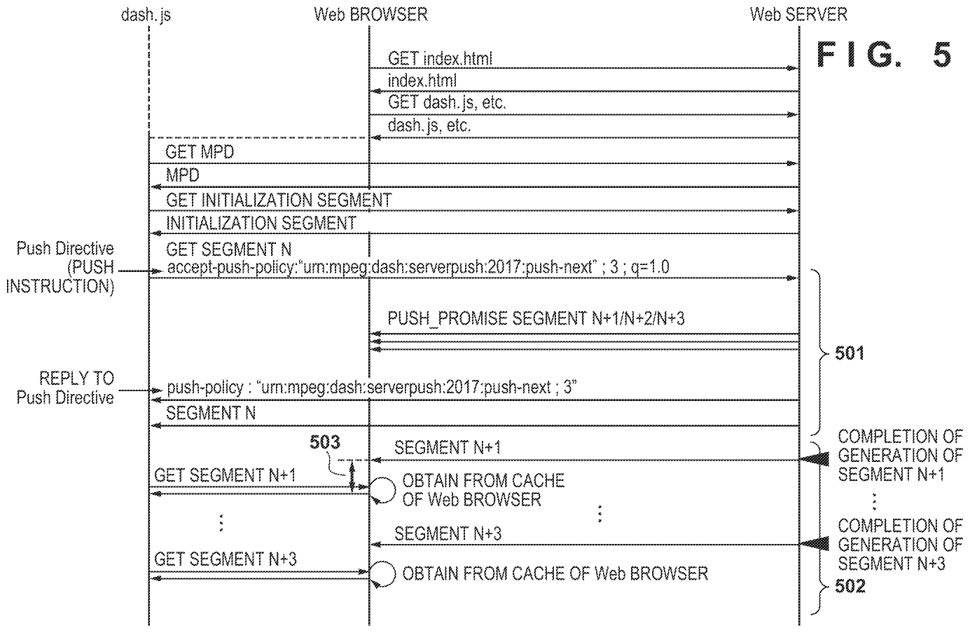

FIG. 4 is a sequence chart exemplarily showing the processing contents of a conventional technique that does not use server push in MPEG-DASH. Note that MPEG-DASH is an acronym of Moving Picture Experts Group-Dynamic Adaptive Streaming over HTTP. In MPEG-DASH, video data is divided into segments each having a predetermined time length, and a URL (Uniform Resource Locator) used to obtain each segment is described in a file called a playlist. A client obtains the playlist first, and requests a desired segment from the transmission apparatus using information described in the playlist, thereby obtaining the segment. For example, obtaining information of a plurality of segments for which the resolution, the bit rate, and the like are different is described in the playlist, and the client requests a desired segment to the server.

Referring to FIG. 4, the Web server has a media data distribution function by MPEG-DASH, and the Web browser is a Web browser that operates in the reception apparatus 100 having the arrangement as shown in FIG. 3. In a sequence 401 shown in FIG. 4, the Web browser first obtains HTML from the Web server, analyzes it, and obtains dash.js that is JavaScript necessary for display of a page from the Web server. Here, dash.js is a Web application that functions as a client of MPEG-DASH. Next, when dash.js is executed on the Web browser, in a sequence 402, dash.js obtains, from the Web server, MPD (Media Presentation Description) that is a playlist of MPEG-DASH. Then, dash.js obtains an initialization segment that is information necessary for decoding a segment. In a sequence 403, dash.js obtains a segment N that is the Nth segment, and then sequentially obtains segments N+1, N+2, . . . . Note that in the sequence shown in FIG. 4, video display is started from the Nth segment. The reception apparatus 100 performs reproduction processing for the thus obtained segment sequentially using the function of the MSE unit 151, thereby executing streaming reproduction of media data. Note that an elapsed time indicated by 404 in FIG. 4 represents a time from completion of generation of the segment N+1 on the Web server side to obtaining of the segment by dash.js.

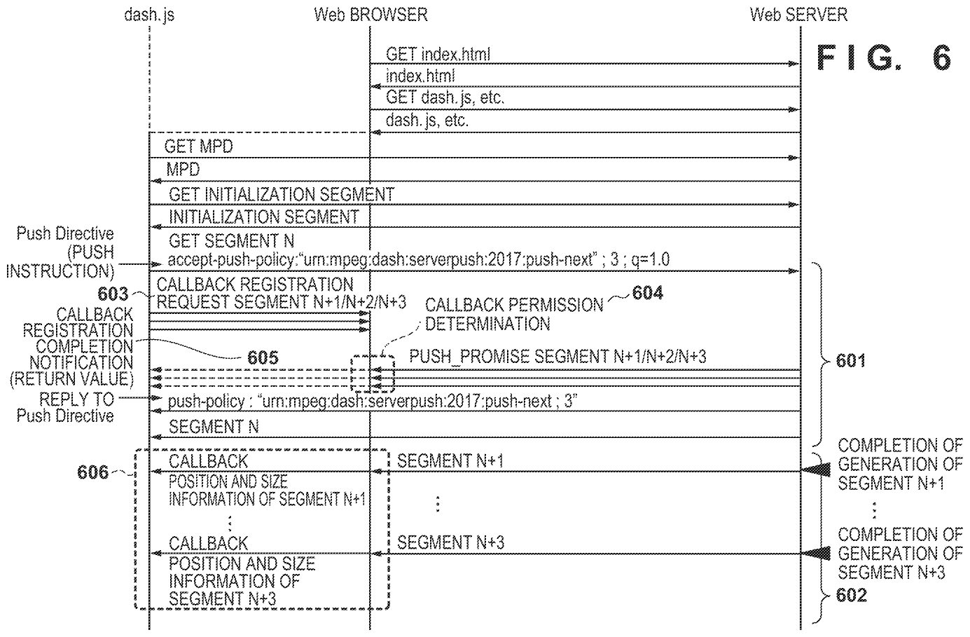

Streaming distribution using HTTP/2 standardized as MPEG-DASH part 6 will be described next with reference to FIG. 5. As described above, in MPEG-DASH, for example, obtaining information of a plurality of segments for which the resolution, the bit rate, and the like are different is described in the playlist, and the client requests a desired segment to the server. On the other hand, in server push, it is general that the Web server decides data to be pushed. Hence, in MPEG-DASH part 6, a mechanism that notifies, from the client to the server, the information of a segment to be pushed is defined.

FIG. 5 is a sequence chart exemplarily showing processing contents using server push in MPEG-DASH. In FIG. 5, processing contents up to obtaining of an initialization segment are the same as the processing contents (sequences 401 and 402) in FIG. 4. In a sequence 501, dash.js sends an obtaining request of the segment N to the Web server, and simultaneously instructs push of the next segment by Push Directive (push instruction) defined by MPEG-DASH part 6. In the description example shown in FIG. 5, a push instruction is represented by an accept-push-policy header, and push distribution of three segments following the segment N is instructed. The Web server receives the segment push instruction. If the instruction can be executed, transmission of the segments N+1, N+2, and N+3 is announced by a PUSH_PROMISE frame defined by HTTP/2. The Web server then returns a reply (push-policy header) to the Push Directive defined by MPEG-DASH part 6 to the Web browser, and transmits the segment N at that time.

In a sequence 502, the Web server push-distributes the segment N+1 to the Web browser as soon as it completes generation of the segment. In this case, the distributed segment N+1 is saved in the cache of the Web browser. After that, dash.js requests the segment N+1 by the GET method, thereby obtaining the segment N+1 from the cache of the Web browser. In FIG. 5, 503 represents the elapsed time from completion of generation of the segment N+1 in the Web server to obtaining of the segment by dash.js. According to the procedure shown in FIG. 5, as compared to the elapsed time 404 in FIG. 4, the time needed for transmission, which is the sum of the time until the obtaining request arrives at the Web server and the time until the requested data arrives from the Web server, is decreased. On the other hand, the timing at which dash.js can actually obtain the data is the timing at which dash.js obtains the pushed data by the GET method. Hence, if the timing of the GET method delays, the elapsed time indicated by 503 in FIG. 5 also becomes long.

Note that dash.js can obtain the segment by calculating, based on the time information described in the MPD, the time at which each segment can be obtained. However, depending on the operation environment of the Web browser in which dash.js operates, the timing of obtaining the segment may shift. As a result, especially when performing long-time streaming reproduction, the time difference from segment generation to segment obtaining by dash.js may be lame.

(Outline of Processing)

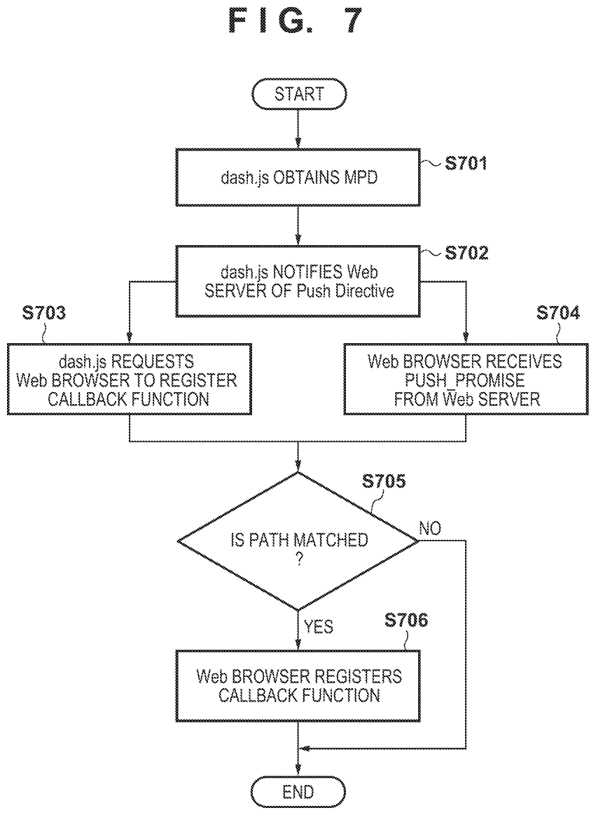

An example of a method of reducing the time difference as described above will be described next. FIG. 6 is a sequence chart showing the processing contents of the reception apparatus according to this embodiment. In FIG. 6 as well, processing contents up to obtaining of an initialization segment are the same as the processing contents of the sequences 401 and 402 in FIG. 4. In a sequence 601, dash.js outputs a push instruction concerning the segments N+1 to N+3, and also issues a callback registration request to the Web browser, as indicated by 603. The callback function is executed by the callback unit 146 when registration is permitted. At the timing of receiving the push-instructed segment, a registered predetermined function is executed. For example, when announcement of push distribution is notified from the Web server by a PUSH_PROMISE fame, in 604 of FIG. 6, the Web browser determines whether to permit callback registration by the callback permission determination unit 147. In this embodiment, only when callback registration is permitted, a callback function is executed. The callback registration determination result can be notified to dash.js as a return value, as indicated by 605. A reply to Push Directive and transmission/obtaining of the segment N after that are the same as in FIG. 5.

Next, in a sequence 602 shown in FIG. 6, the Web server transmits the segment N+1 to the Web browser as soon as it generates the segment. In this case, the Web browser executes the registered predetermined function, as indicated by 606 in FIG. 6. When the predetermined function is executed by the Web browser, dash.js can know, for example, the position at which the segment N+1 is saved and the information of the size. By the information, dash.js can obtain the segment N+1. At this time, the segment N+1 is saved in a region accessible from dash.js. However, the present invention is not limited to this, and the segment N+1 may be saved in a region inaccessible from dash.js. If the segment N+1 is saved in a region inaccessible from dash.js, dash.js can execute processing of moving the segment N+1 to an accessible region by, for example, an API provided by the Web browser or the like. As for the segment N+2 and the segment N+3 as well, the Web server transmits the segment as soon as it generates the segment. Upon receiving the segment, the Web browser executes the callback-registered predetermined function. Accordingly, dash.js can start reproduction processing without making the segment stay in the Web browser.

(Procedure of Processing)

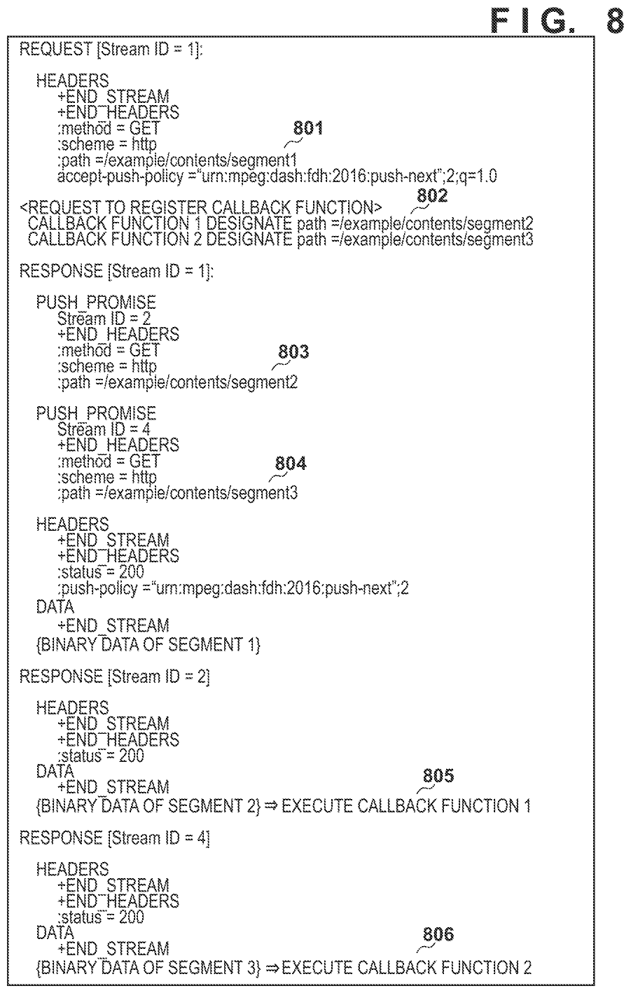

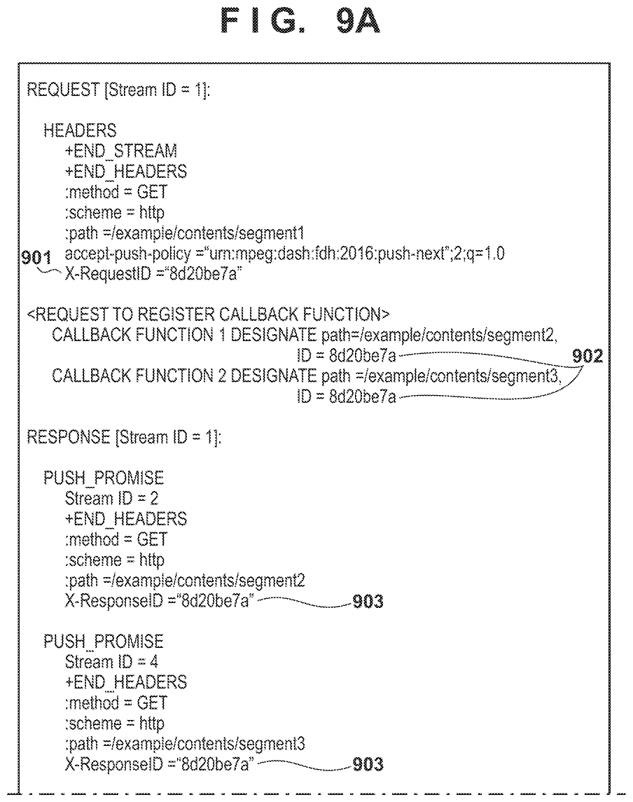

Processing contents of the callback permission determination unit 147 of the reception apparatus 100 according to this embodiment will be described next with reference to FIGS. 7 and 8. FIG. 7 shows an example of the procedure of callback permission determination of the reception apparatus 100 according to this embodiment. Each step shown in the flowchart of FIG. 7 is executed when, for example, the control unit 122 of the reception apparatus reads out a program stored in the storage unit 121 and executes it. FIG. 8 is a view for explaining an example of a request of a push instruction and a response by a Web server according to this embodiment. In FIG. 7, dash.js obtains an MPD (step S701) first, and notifies the Web server of Push Directive, thereby issuing a push instruction (step S702). Then, dash.js requests the Web browser to register a callback function (step S703).

The processing of steps S702 and S703 will be described here with reference to FIG. 8. First, in step S702, dash.js requests segment 1 by the description of a “:path” header indicated by 801 in FIG. 8. In addition, dash.js instructs push distribution of two segments (segments 2 and 3) following requested segment 1 by an “accept-push-policy” header. In step S703, dash.js requests registration of a callback function to be invoked when a push-instructed segment is received. As indicated by 802 in FIG. 8, for each of callback functions 1 and 2 that are invoked upon receiving segments 2 and 3, dash.js notifies the Web browser of the path information of each of segments 2 and 3.

On the other hand, upon accepting a segment push instruction, the Web server notifies the Web browser of a PUSH_PROMISE frame to make an announcement of push distribution in step S704 of FIG. 7. The PUSH_PROMISE frame at this time includes the path information of each data to be pushed, as indicated by 803 and 804 in FIG. 8. In step S705, the Web browser determines whether the path information notified at the time of callback function registration request in step S703 matches the path information in the PUSH_PROMISE frame received in step S704. In the example shown in FIG. 8, these pieces of path information are “/example/contents/segment2” and “/example/contents/segment3” and match. If these paths match, in step S706, the Web browser registers the requested callback functions. The Web browser executes corresponding callback functions 1 and 2 in accordance with the reception of segments 2 and 3, as indicated by 805 and 806 in FIG. 8. Note that, for example, if the Web browser receives an announcement of another push distribution from the Web server, the path information of data included in the announcement of push distribution does not match the path information notified from dash.js. For this reason, the Web browser does not execute a callback function for this push distribution (without path information matching). When push-distributed data is received, only for data requested by an application in advance, the Web browser can automatically execute a predetermined function to allow the application to use the data. Hence, for example, if data other than data requested in MPEG-DASH is received, it is possible to prevent execution of unnecessary processing of, for example, providing information concerning the data to dash.js.

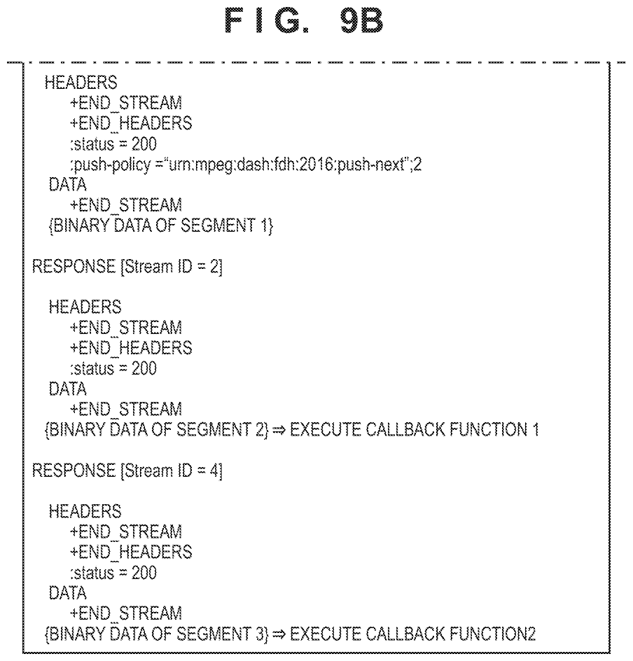

Note that the example of the request of the push instruction and the response by the Web server in FIG. 8 is merely an example, and another format may be used. FIGS. 9A and 9B show another example of the request of the push instruction and the response by the Web server. In the example shown in FIGS. 9A and 9B, the association between the push instruction and PUSH_PROMISE is explicitly shown, thereby improving security.

In the example shown in FIG. 8, a method of checking, by comparison, whether paths match as a condition to determine whether to permit registration of a callback function has been described. On the other hand, if a mechanism configured to push data based on an instruction from the client side is used, as in MPEG-DASH, the association between the push instruction and PUSH_PROMISE is explicitly shown, thereby improving security. In the example shown in FIGS. 9A and 9B, as indicated by 901, for example, an arbitrary header “X-RequestID” is added as an identifier used to identify a push instruction, and the Web server is notified of the identifier. Additionally, as indicated by 902 in FIGS. 9A and 9B, the identifier is designated together with path information in the callback function registration request as well.

On the other hand, as indicated by 903 in FIGS. 9A and 9B, the Web server adds, for example, an arbitrary header “X-ResponseID” to the PUSH_PROMISE frame, and describes the identifier notified by the push instruction. The push instruction and PUSH_PROMISE are associated in this way. Additionally, in the callback function registration permission judgment, the Web browser uses, as a judgment condition, matching between the identifier indicated by 902 in FIGS. 9A and 9B and the identifier described in the PUSH_PROMISE frame indicated by 903. This condition may be used in addition to the above-described matching of paths, or may be used in place of the matching of paths. This can further clarify that the PUSH_PROMISE is generated by the push instruction. As the identifier used to identify the push instruction, a different identifier can be used for each push instruction. This can prevent the push instruction and PUSH_PROMISE that does not correspond originally from being associated.

Note that in FIGS. 9A and 9B, an example in which arbitrary identifiers are added to the push instruction and the push announcement and compared has been described. However, another information capable of clarifying that the PUSH_PROMISE is generated by the push instruction may be used. For example, comparison using a hash value obtained by performing predetermined calculation processing for the identifier or path information may be performed, or authentication token information or the like may be added to specify that the PUSH_PROMISE is generated by the push instruction. That is, the information designated by the callback function registration request from dash.js and the information included in the PUSH_PROMISE need not always match as long as their correspondence relationship can uniquely be specified.

Note that in this embodiment, only a predetermined function permitted by the callback permission determination unit 147 is callback-executed. For this reason, any function can be prevented from being callback-executed because of data that is obtained by the Web browser but not associated with media data. It is therefore possible to prevent unnecessary data from being received by an application in accordance with execution of an unnecessary function, and the application can obtain necessary data without any delay.

Note that in the above-described example, a case in which media data is obtained based on MPEG-DASH using the server push function by HTTP/2 has been described. This is merely an example, and a method other than the described standard may be used. That is, an arbitrary method can be used as long as the reception apparatus designates data and requests push distribution, a device other than an application obtains data distributed in accordance with the request, and the application can use the data. For example, push distribution may be executed in accordance with a standard other than HTTP/2, and a distributed data request may be done in accordance with a standard other than MPEG-DASH. No matter what standard is used, the reception apparatus can execute a predetermined function registered in advance based on reception of push-distributed data, and allow the application to use the data. At this time, the reception apparatus decides whether to register the predetermined function based on the information obtained at the time of the predetermined function registration request and the information (for example, a push distribution announcement) obtained from the apparatus of the data distribution source (for example, the Web server). For example, if information (for example, path information or an identifier) notified in advance from a predetermined application is included in the information obtained from the apparatus of the data distribution source, the reception apparatus decides to register the predetermined function.

According to the present invention, it is possible to shorten a time until, in the reception apparatus, a specific application can use data obtained by push from the partner apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-034738, filed on Feb. 27, 2019, which is hereby incorporated by reference herein in its entirety.

What is claimed is:

1. A reception apparatus configured to receive push-distributed data from another apparatus, comprising:
one or more processors; and
one or more memories, which stores one or more computer-readable instructions that cause, when executed by the one or more processors, the reception apparatus to:
determine, based on information of data to be push-distributed, whether to register a predetermined function used to allow a predetermined application to use the data;
register the predetermined function determined to be registered in the determination; and
execute the predetermined function when the push-distributed data is received if, concerning the data, the predetermined function has been registered by the registration.

2. The apparatus according to claim 1, wherein the predetermined application requests registration of the predetermined function, and
if information designated in the request corresponds to information included in an announcement of push distribution received from the other apparatus, it is determined, in the determination, to register the predetermined function concerning the data to be push-distributed.

3. The apparatus according to claim 2, wherein if path information of the data to be push-distributed, which is designated in the request, matches path information of the data to be push-distributed, which is included in the announcement, it is determined, in the determination, to register the predetermined function concerning the data to be push-distributed.

4. The apparatus according to claim 2, wherein if an identifier of the data to be push-distributed, which is designated in the request, matches an identifier of the data to be push-distributed, which is included in the announcement, it is determined, in the determination, to register the predetermined function concerning the data to be push-distributed.

5. The apparatus according to claim 4, wherein the one or more computer-readable instructions cause, when executed by the one or more processors, the reception apparatus to instruct the other apparatus to transmit the data by push distribution, and
the instruction including the identifier is transmitted to the other apparatus, and
the announcement is transmitted from the other apparatus in accordance with the instruction.

6. The apparatus according to claim 5, wherein the instruction is performed using Push Directive of MPEG-DASH (Moving Picture Experts Group-Dynamic Adaptive Streaming over HTTP) part 6.

7. The apparatus according to claim 2, wherein the announcement is performed by PUSH_PROMISE of HTTP (HyperText Transfer Protocol)/2.

8. The apparatus according to claim 1, wherein push distribution is performed by server push of HTTP (HyperText Transfer Protocol)/2.

9. The apparatus according to claim 1, wherein when the predetermined function is executed, the predetermined application is notified of information used by the predetermined application to obtain the push-distributed data.

10. A control method executed by a reception apparatus configured to receive push-distributed data from another apparatus, comprising:
determining, based on information of data to be push-distributed, whether to register a predetermined function used to allow a predetermined application to use the data;
registering the predetermined function determined to be registered in the determining; and
executing the predetermined function when the push-distributed data is received if, concerning the data, the predetermined function has been registered in the registering.

11. A non-transitory computer-readable storage medium that stores a program configured to cause a computer provided in a reception apparatus configured to receive push-distributed data from another apparatus to:
determine, based on information of data to be push-distributed, whether to register a predetermined function used to allow a predetermined application to use the data;
register the predetermined function determined to be registered in the determination; and
execute the predetermined function when the push-distributed data is received if, concerning the data, the predetermined function has been registered by the registration.
